(19) United States
(12) Patent Application Publication
(10) Pub. No.: US 2025/0029152 A1
(43) Pub. Date: Jan. 23, 2025

(54) Playing Different Advertising in Media Seamlessly

(71) Applicant: International Business Machines Corporation, Armonk, NY (US)

(72) Inventors: Satyam Jakkula, Bangalore (IN); Sarbajit K. Rakshit, Kolkata (IN); Sudhanshu Sekher Sar, Bangalore (IN); Sudheesh S. Kairali, Kozhikode (IN)

(21) Appl. No.: 18/354,756

(22) Filed: Jul. 19, 2023

(51) Int. Cl. G06Q 30/0241; G06Q 30/0273

(52) U.S. Cl. CPC G06Q 30/0277; G06Q 30/0275; H04N 21/812

(57) ABSTRACT

Dynamically overlaying advertising on media seamlessly is provided. An advertisement generator is directed to generate advertising corresponding to each particular winning entity on an e-auction website in response to an e-auction component assigning advertising rights to corresponding winning entities. The advertising corresponding to each particular winning entity is overlayed on a specific set of virtual advertisement placeholders assigned to that particular winning entity within media dynamically while the media is playing on a set of client devices without stopping scene flow of the media.

### BACKGROUND

The disclosure relates generally to advertising and more specifically to playing different virtual advertising in media seamlessly.

Advertising is a marketing practice involving paying for space to promote a product or service. In other words, advertising is the practice and techniques employed to bring attention to a product or service. Advertising aims to put a product or service in the spotlight in hopes of drawing attention from consumers. The promotional messages are called advertisements, or ads for short. The goal of advertising is to reach people likely to pay for products or services and entice them to buy. Even though advertising is typically used to promote a specific good or service, there are a wide range of other uses, such as commercial advertisement. Commercial advertisements often seek to generate increased consumption of their products or services through branding, which associates a product name or image with certain qualities in the minds of consumers.

### SUMMARY

According to one illustrative embodiment, a computer-implemented method for dynamically overlaying advertising on media seamlessly is provided. A computer directs an advertisement generator to generate advertising corresponding to each particular winning entity on an e-auction website in response to an e-auction component assigning advertising rights to corresponding winning entities. The computer overlays the advertising corresponding to each particular winning entity on a specific set of virtual advertisement placeholders assigned to that particular winning entity within media dynamically while the media is playing on a set of client devices without stopping scene flow of the media. According to other illustrative embodiments, a computer system and computer program product for dynamically overlaying advertising on media seamlessly are provided.

### BRIEF DESCRIPTION OF THE DRAWINGS

FIG. 1 is a pictorial representation of a computing environment in which illustrative embodiments may be implemented;

FIG. 2 is a diagram illustrating an example of a virtual advertisement placeholder placement system in accordance with an illustrative embodiment;

FIG. 3 is a diagram illustrating an example of a virtual advertisement placeholder in accordance with an illustrative embodiment;

FIG. 4 is a diagram illustrating another example of a virtual advertisement placeholder in accordance with an illustrative embodiment;

FIG. 5 is a diagram illustrating an example of advertising in accordance with an illustrative embodiment;

FIG. 6 is a diagram illustrating another example of advertising in accordance with an illustrative embodiment; and

FIGS. 7A-7B are a flowchart illustrating a process for dynamically overlaying advertising on media seamlessly in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

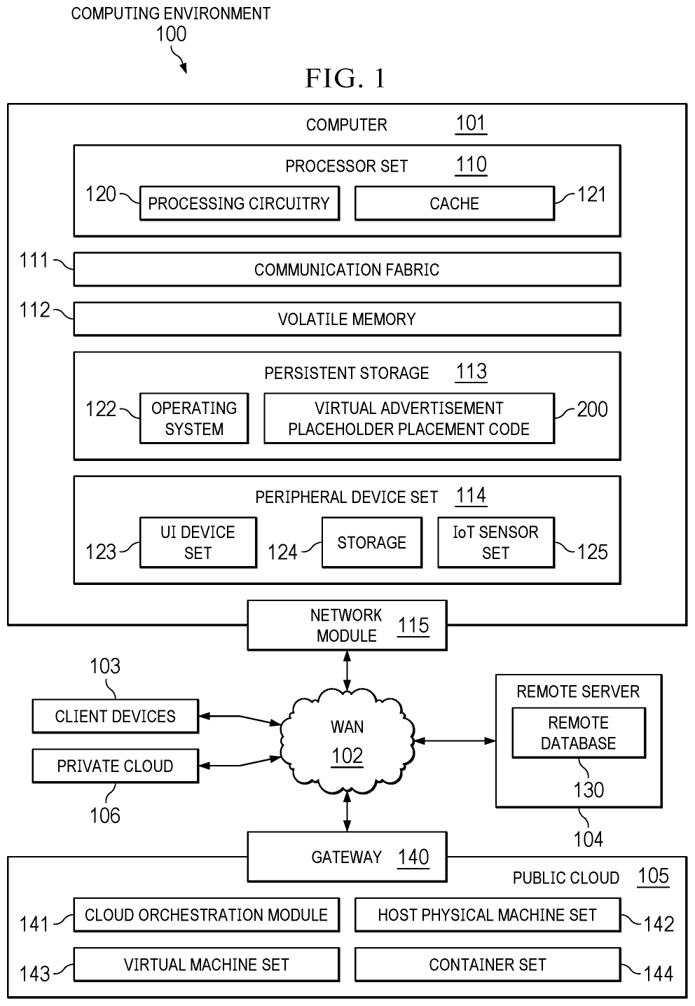

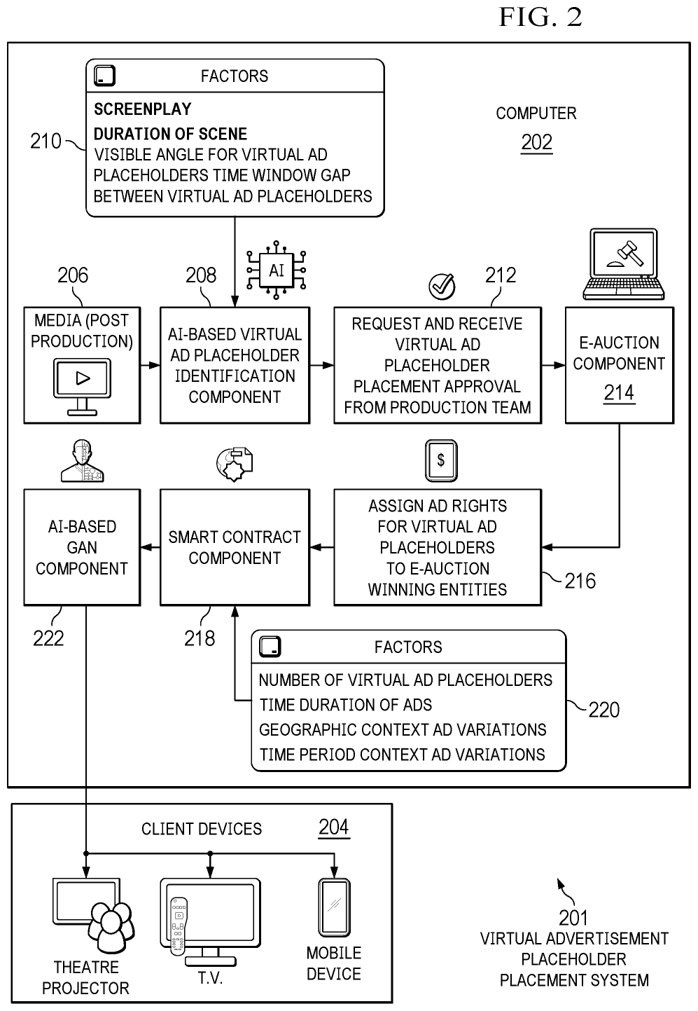

With reference now to the figures, and in particular, with reference to FIG. 1 and FIG. 2, diagrams of data processing environments are provided in which illustrative embodiments may be implemented. It should be appreciated that FIG. 1 and FIG. 2 are only meant as examples and are not intended to assert or imply any limitation with regard to the environments in which different embodiments may be implemented. Many modifications to the depicted environments may be made.

FIG. 1 shows a pictorial representation of a computing environment in which illustrative embodiments may be implemented. Computing environment 100 contains an example of an environment for the execution of at least some of the computer code involved in performing the inventive methods of illustrative embodiments, such as virtual advertisement placeholder placement code 200. For example, virtual advertisement placeholder placement code 200 utilizes artificial intelligence (e.g., a set of machine learning models) to identify areas in media for placement of virtual advertisement placeholders while the media is in the production phase or postproduction phase. The media can be, for example, a movie, film, social media video, television program, gaming video, or the like. A media production team can approve the identified areas for the placement of the virtual advertisement placeholders within the media. Virtual advertisement placeholder placement code 200 identifies the areas for the virtual advertisement placeholders based on, for example, a plurality of factors, such as, screenplay corresponding to the media, duration of particular scenes in the media, audience viewing angle of a virtual advertisement placeholder in the media, time window gap between virtual advertisement placeholders in the media, and the like. Virtual advertisement placeholder placement code 200 utilizes a smart contract component to govern a multi-dimensional advertisement generator to generate advertisements based on, for example, number and type of virtual advertisement placeholders in the media, time duration of advertisements, contextual variations of advertisements based on geographic location and time of media play, and the like. In addition, virtual advertisement placeholder placement code 200 utilizes a generative adversarial network component to automatically and seamlessly overlap particular advertisements on specific virtual advertisement placeholders within the media while the media is playing without halting the actual scene flow of the media.

In addition to virtual advertisement placeholder placement code 200, computing environment 100 includes, for example, computer 101, wide area network (WAN) 102, client devices 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and virtual advertisement placeholder placement code 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, mainframe computer, quantum computer, or any other form of computer now known or to be developed in the future that is capable of, for example, running a program, accessing a network, and querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods of illustrative embodiments may be stored in virtual advertisement placeholder placement code 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports, and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The virtual advertisement placeholder placement code included in block 200 includes at least some of the computer code involved in performing the inventive methods of illustrative embodiments.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks, and even connections made through wide area networks such as the internet. In various embodiments, UI device set 123 may include components such as a display screen, speaker, microphone, wearable devices (such as smart glasses and smart watches), keyboard, mouse, touchpad, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

Client devices 103 represent a plurality of devices capable of displaying media to a viewing audience. Client devices 103 typically receives data from the operations of computer 101. For example, in a hypothetical case where computer 101 is designed to dynamically overlay advertising on media being displayed to client device users, this dynamically overlayed advertising would typically be communicated from network module 115 of computer 101 through WAN 102 to client devices 103. In this way, client devices 103 can display, or otherwise present, the media with the dynamically overlayed advertising to the client device users. In some embodiments, client devices 103 may be thin clients, heavy clients, theater projectors, televisions, desktop computers, laptop computers, tablet computers, smart phones, smart glasses, smart watches, augmented reality devices, and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to dynamically overlay advertising on media based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single entity. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

As used herein, when used with reference to items, “a set of” means one or more of the items. For example, a set of clouds is one or more different types of cloud environments. Similarly, “a number of,” when used with reference to items, means one or more of the items. Moreover, “a group of” or “a plurality of” when used with reference to items, means two or more of the items.

Further, the term “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item B. This example may also include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

Entities, such as, for example, businesses, companies, enterprises, organizations, institutions, agencies, and the like, utilize advertising programs to get noticed and attract people (e.g., customers, clients, supporters, investors, donors, users, and the like) to them. For example, entities can utilize different advertising channels to reach out to people regarding their products, services, offerings, programs, and the like. Advertising channels at a high level include traditional advertising channels and digital advertising channels.

Traditional advertising channels include, for example: outdoor advertising such as billboards, vehicle wraps, posters, and the like; broadcast advertising such as television, radio, and the like; print advertising such as magazines, newspapers, and the like; direct mail advertising such as catalogs, mailings, and the like; telemarketing advertising such as phone calls, text messages, and the like; and window displays and signs advertising. Digital advertising channels include, for example, social media platform advertising, website advertising, content marketing, affiliate marketing, inbound marketing, email marketing, pay per click marketing, and search engine marketing. Each advertising channel has its own reach for target audiences and the impact it generates. As television gets smarter with internet, television broadcasting is fading the line between traditional and digital advertising channels.

Current advertising programs of entities have certain issues or shortcomings. For example, an entity is advertising via television or social media platform. The television or social media platform is playing the media (e.g., movie, video, or the like) and suddenly an advertisement (e.g., sub-media) is introduced for a brief period. During this brief period, the content of the media is stopped until the sub-media (i.e., the advertisement) has completed playing. The transition between the media and the sub-media is mutually exclusive (i.e., the media cannot play while the sub-media is playing and vice versa).

As another example, entities vie for prime advertisement spots on television, billboards, and the like, which do not have scalability for multiple entities. For example, during holiday periods, entities, such as, for example, hardware stores, athletic stores, outdoor activity stores, furniture stores, and the like, compete with each other for these prime advertising spots to attract people to their products, offerings, services, and the like. However, these prime advertising spots are not scalable.

As yet another example, revenue for in-theater or television program advertising is limited to traditional advertising rights. However, advertising revenue should be scalable to producers of the media as well. In other words, a win-win-win should exist for the media producers, advertising entities, and viewing audiences. For example, providing virtual advertisement placeholders in media (e.g., a blockbuster movie) with expected high audience attendance can create competition among advertising entities, allow widespread audience reach, and produce revenue for the media producers from entities advertising in the virtual advertisement placeholders located within the media.

Illustrative embodiments utilize artificial intelligence to identify placement of virtual advertisement placeholders within content (e.g., scenes, frames, or the like) of media, such as, for example, a movie, television program, social media video, gaming video, or the like, while the media is the production phase or post-production phase. A virtual advertisement placeholder reserves a defined location, area, or space within the media to display advertising (e.g., an image, picture, graphic, video, or the like), which corresponds to a particular entity. Illustrative embodiments send a notification to the production team of the media to review and approve the positions of the virtual advertisement placeholders within the media.

Based on the production team approving positioning of virtual advertisement placeholders within the media, illustrative embodiments utilize an e-auction component to generate a website for an e-auction, which enables bidding by different entities to reserve or procure a set of virtual advertisement placeholders for their advertising within the media. The e-auctioning of a set of virtual advertisement placeholders grants multi-dimensional advertising rights to a particular entity that won the bidding for that particular set of virtual advertisement placeholders. The multi-dimensional advertising rights granted for that particular set of virtual advertisement placeholders include, for example: specific locations within the media for the set of virtual advertisement placeholders including the specific number and type of placeholders; time duration of the advertising within a particular scene of the media (e.g., how long the audience can see the advertisement in the scene while the movie is playing); contextual variations of the advertising within the set of virtual advertisement placeholders based on geographic location where the media is playing (e.g., if the set of virtual advertisement placeholders are located at scenes x, y, and z of the movie and the movie is playing in a particular geographic location, then illustrative embodiments can include a local celebrity in the advertisement at scenes x, y, and z based on that particular geographic location where the media is being viewed by an audience); and contextual variations of the advertising within the set of virtual advertisement placeholders based on time of day when the media playing (e.g., illustrative embodiments can vary the advertising based on whether the media is playing in the morning, afternoon, evening, or at night).

Based on the multi-dimensional advertising rights granted by the e-auction component to different entities that won the bidding for particular virtual advertising placeholders within the media, illustrative embodiments dynamically vary the advertising between the entities who won the multi-dimensional advertising rights. For example, when the media is playing in the afternoon, illustrative embodiments can display advertising for a first entity that won the bidding for the virtual advertising placeholders, and when the media is playing in the evening, illustrative embodiments can display advertising for a second entity that also won the bidding for the virtual advertising placeholders. Illustrative embodiments utilize an artificial intelligence-based generative adversarial network component to seamlessly overlap sub-media (i.e., the image or video containing the advertising) on the media (e.g., movie, television program, or the like) without stopping the actual scene flow of the media.

Thus, illustrative embodiments provide one or more technical solutions that overcome a technical problem with an inability of current solutions to dynamically overlay advertising on media while the media is playing without halting the scene flow of the media. As a result, these one or more technical solutions provide a technical effect and practical application in the field of media play.

With reference now to FIG. 2, a diagram illustrating an example of a virtual advertisement placeholder placement system is depicted in accordance with an illustrative embodiment. Virtual advertisement placeholder placement system 201 may be implemented in a computing environment, such as computing environment 100 in FIG. 1. Virtual advertisement placeholder placement system 201 is a system of hardware and software components for dynamically overlaying advertising on media seamlessly.

In this example, virtual advertisement placeholder placement system 201 includes computer 202 and client devices 204. Computer 202 and client devices 204 may be, for example, computer 101 and client devices 103 in FIG. 1. However, it should be noted that virtual advertisement placeholder placement system 201 is intended as an example only and not as a limitation on illustrative embodiments. For example, virtual advertisement placeholder placement system 201 can include any number of computers, client devices, and other devices and components not shown.

Computer 202 receives media 206 (e.g., postproduction). Media 206 may be, for example, a movie, television program, social media video, gaming video, film, or the like. Computer 202 inputs media 206 in artificial intelligence (AI)-based virtual advertisement placeholder identification component 208. Computer 202 utilizes AI-based virtual advertisement placeholder identification component 208 to identify positions for virtual advertisement placeholders within media 206 based on factors 210. In this example, factors 210 include a plurality of different factors such as screenplay, duration of scene, viewing angle for virtual advertisement placeholders, and time window gap between virtual advertisement placeholders. For example, if the screenplay of media 206 indicates a forest with thick trees in a particular scene, then AI-based virtual advertisement placeholder identification component 208 will not select that scene for placement of a virtual advertisement placeholder because it will take away from the beauty of the scene and be distracting to the audience. In addition, if duration of a particular scene is greater than a scene duration threshold and little to no action is taking place in that particular scene, then AI-based virtual advertisement placeholder identification component 208 will select that particular scene for placement of a virtual advertisement placeholder in the background, for example. Further, if the visible advertising viewing angle of a virtual advertisement placeholder in a scene will not be between predefined degrees in both the horizontal plane and vertical plane, then AI-based virtual advertisement placeholder identification component 208 will not select that scene for placement of a virtual advertisement placeholder because of poor advertising visibility. Furthermore, AI-based virtual advertisement placeholder identification component 208 takes into account a predefined minimum time window gap between respective virtual advertisement placeholders to prevent too many advertisements appearing in media 206 in too short a period of time to avoid advertising clutter in media 206 and audience distraction.

At 212, computer 202 requests and receives virtual advertisement placeholder placement approval from the production team of media 206. In response to receiving virtual advertisement placeholder placement approval in media 206 from the production team, computer 202 utilizes e-auction component 214 to generate an e-auction website that accepts bids from entities for different virtual advertisement placeholders within media 206. It should be noted that an entity can bid for at least one of international, national, regional, and local advertising rights. At 216, at the end of the e-auction, e-auction component 214 grants and assigns advertising rights for virtual advertisement placeholders to e-auction winning entities. It should be noted that e-auction component 214 can grant and assign advertising rights for virtual advertisement placeholders to multiple entities based on geographic and time variations of advertising depending on where and when media 206 will be played (e.g., if media 206 will be played in one country, e-auction component 214 can grant and assign advertising rights for particular virtual advertisement placeholders in media 206 to a first entity that sells a particular type of product, and if media 206 will be simultaneously played in another country where the first entity does not operate, e-auction component 214 can grant and assign advertising rights for the same virtual advertisement placeholders in media 206 to a second entity that sells the same type of product.

In response to assigning the advertising rights by e-auction component 214 to the winning e-auction entities, computer 202 utilizes smart contract component 218 to direct a multi-dimensional advertisement generator to generate advertising, which will be overlayed on the virtual advertisement placeholders within media 206, corresponding to the winning e-auction entities based on factors 220. The advertising can include, for example, an image, picture, graphic, logo, trademark, video, or any combination thereof. In this example, factors 220 include a plurality of different factors such as number of virtual advertisement placeholders corresponding to a particular entity, time duration of how long the advertising corresponding to that particular entity will be viewed while media 206 is playing, geographic context advertisement variations as to where media 206 is playing, and time period context advertisement variations as to when media 206 is playing.

Computer 202 utilizes AI-based generative adversarial network (GAN) component 222 to dynamically overlay the advertising, which was generated by the multi-dimensional advertisement generator under the direction of smart contract component 218, on specific virtual advertisement placeholders assigned to the winning e-auction entities within media 206 while media 206 is playing on at least one of client devices 204 without stopping the actual scene flow of the media. In this example, client devices 204 include a theater projector, a television, and a mobile device. However, it should be noted that client devices 204 are meant as examples only and can include any number and type of client devices that can display media 206.

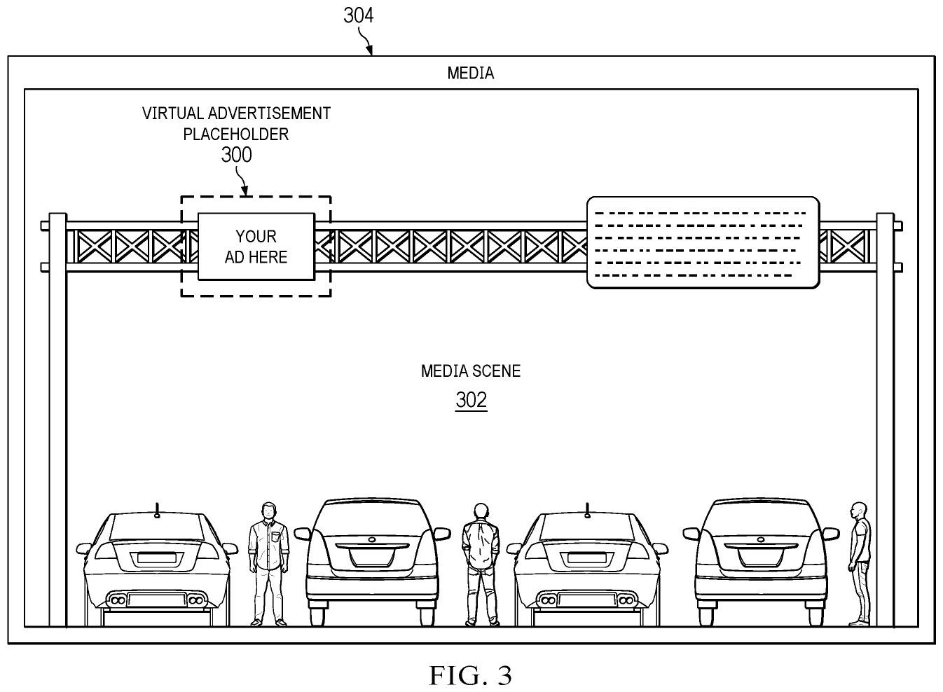

With reference now to FIG. 3, a diagram illustrating an example of a virtual advertisement placeholder is depicted in accordance with an illustrative embodiment. Virtual advertisement placeholder 300 is implemented in media scene 302 of media 304. Media 304 may be, for example, media 206 in FIG. 2. A computer, such as, for example, computer 202 in FIG. 2, utilizes an AI-based virtual advertisement placeholder identification component, such as, for example, AI-based virtual advertisement placeholder identification component 208 in FIG. 2, to identify the placement of virtual advertisement placeholder 300 within media scene 302 of media 304 based on a plurality of different factors, such as, for example, factors 210 in FIG. 2. Virtual advertisement placeholder 300 enables an entity to display advertising on virtual advertisement placeholder 300 within media scene 302 of media 304 while media 304 is playing without stopping media 304.

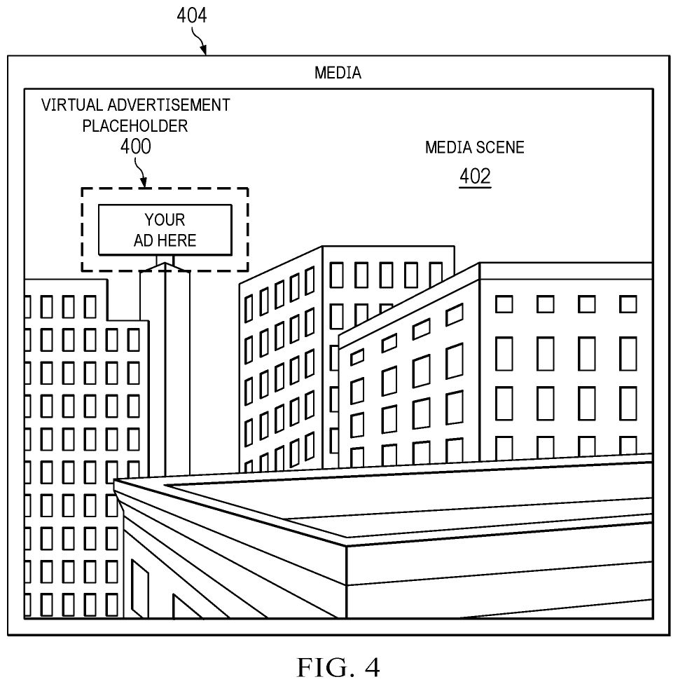

With reference now to FIG. 4, a diagram illustrating another example of a virtual advertisement placeholder is depicted in accordance with an illustrative embodiment. Virtual advertisement placeholder 400 is implemented in media scene 402 of media 404. Media 404 may be, for example, the same as media 304 in FIG. 3. However, media scene 402 is a different scene within the same media.

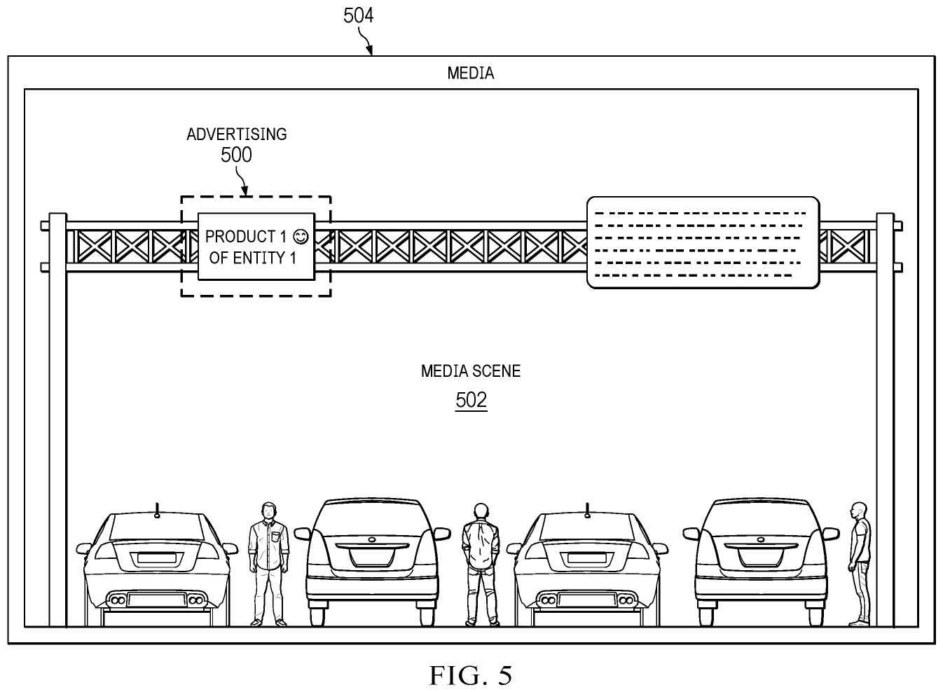

With reference now to FIG. 5, a diagram illustrating an example of advertising is depicted in accordance with an illustrative embodiment. Advertising 500 is implemented in media scene 502 of media 504. It should be noted that media scene 502 is the same as media scene 302 in FIG. 3. In this example, a computer, such as, for example, computer 202 in FIG. 2, utilizes an AI-based GAN component, such as, for example, AI-based GAN component 222 in FIG. 2, to display advertising 500, which corresponds to product 1 of entity 1, on a virtual advertisement placeholder, such as, for example, virtual advertisement placeholder 300 in FIG. 3, as media 504 is playing and being viewed by an audience.

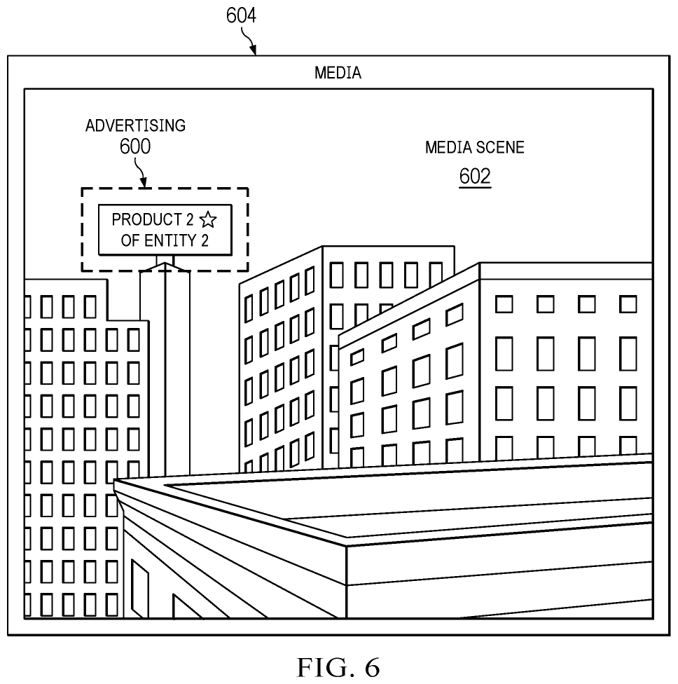

With reference now to FIG. 6, a diagram illustrating another example of advertising is depicted in accordance with an illustrative embodiment. Advertising 600 is implemented in media scene 602 of media 604, such as, for example, media scene 402 of media 404 in FIG. 4. In this example, a computer, such as, for example, computer 202 in FIG. 2, utilizes an AI-based GAN component, such as, for example, AI-based GAN component 222 in FIG. 2, to display advertising 600, which corresponds to product 2 of entity 2, on a virtual advertisement placeholder, such as, for example, virtual advertisement placeholder 400 in FIG. 4, as media 604 is playing and being viewed by an audience.

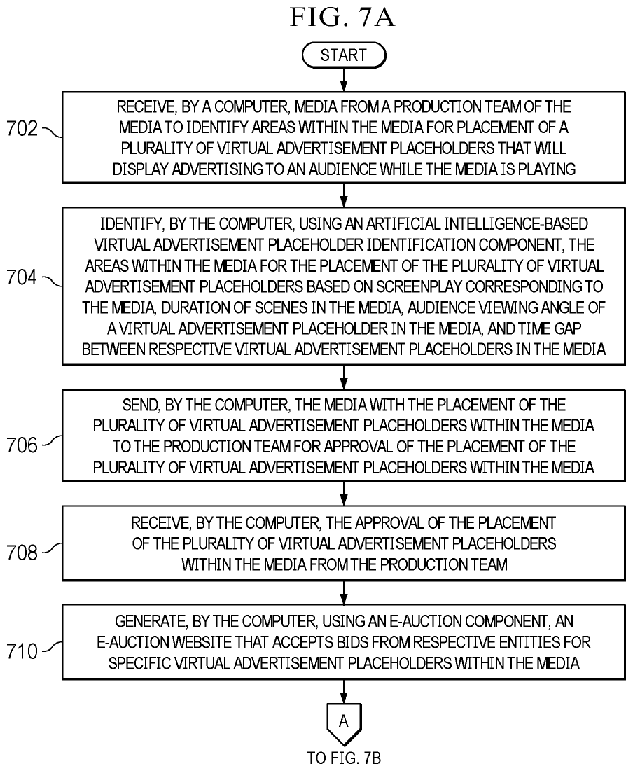

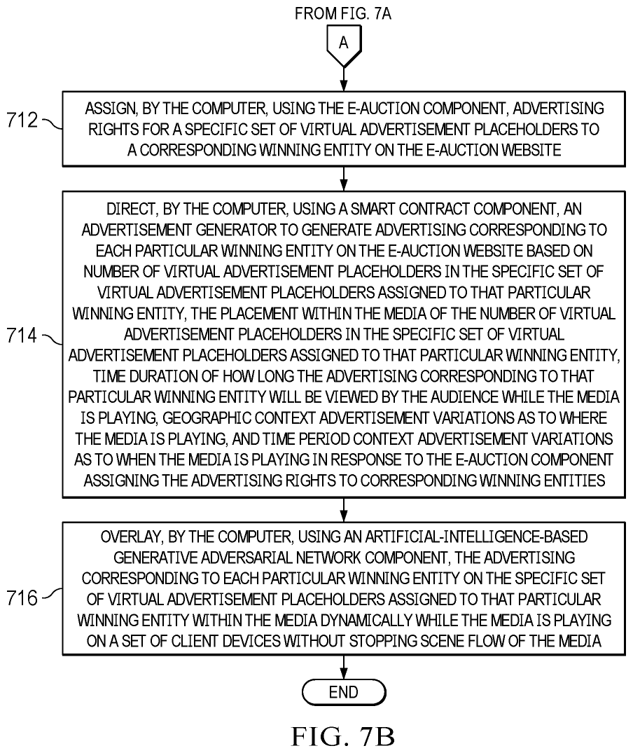

With reference now to FIGS. 7A-7B, a flowchart illustrating a process for dynamically overlaying advertising on media seamlessly is shown in accordance with an illustrative embodiment. The process shown in FIGS. 7A-7B may be implemented in a computer, such as, for example, computer 101 in FIG. 1 or computer 202 in FIG. 2. For example, the process shown in FIGS. 7A-7B may be implemented in virtual advertisement placeholder placement code 200 in FIG. 1.

The process begins when the computer receives media from a production team of the media to identify areas within the media for placement of a plurality of virtual advertisement placeholders that will display advertising to an audience while the media is playing (step 702). In response to receiving the media, the computer, using an artificial intelligence-based virtual advertisement placeholder identification component, identifies the areas within the media for the placement of the plurality of virtual advertisement placeholders based on screenplay corresponding to the media, duration of scenes in the media, audience viewing angle of a virtual advertisement placeholder in the media, and time gap between respective virtual advertisement placeholders in the media (step 704).

In response to identifying the areas within the media for the placement of the plurality of virtual advertisement placeholders, the computer sends the media with the placement of the plurality of virtual advertisement placeholders within the media to the production team for approval of the placement of the plurality of virtual advertisement placeholders within the media (step 706). Subsequently, the computer receives the approval of the placement of the plurality of virtual advertisement placeholders within the media from the production team (step 708).

In response to receiving the approval of the placement of the plurality of virtual advertisement placeholders within the media from the production team, the computer, using an e-auction component, generates an e-auction website that accepts bids from respective entities for specific virtual advertisement placeholders within the media (step 710). The computer, using the e-auction component, assigns advertising rights for a specific set of virtual advertisement placeholders to a corresponding winning entity on the e-auction website (step 712).

Further, the computer, using a smart contract component, directs an advertisement generator to generate advertising corresponding to each particular winning entity on the e-auction website based on number of virtual advertisement placeholders in the specific set of virtual advertisement placeholders assigned to that particular winning entity, the placement within the media of the number of virtual advertisement placeholders in the specific set of virtual advertisement placeholders assigned to that particular winning entity, time duration of how long the advertising corresponding to that particular winning entity will be viewed by the audience while the media is playing, geographic context advertisement variations as to where the media is playing, and time period context advertisement variations as to when the media is playing in response to the e-auction component assigning the advertising rights to corresponding winning entities (step 714). Furthermore, the computer, using an artificial-intelligence-based generative adversarial network component, overlays the advertising corresponding to each particular winning entity on the specific set of virtual advertisement placeholders assigned to that particular winning entity within the media dynamically while the media is playing on a set of client devices without stopping scene flow of the media (step 716). Thereafter, the process terminates when the media ends.

Thus, illustrative embodiments of the present disclosure provide a computer-implemented method, computer system, and computer program product for dynamically overlaying advertising on media seamlessly. The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for dynamically overlaying advertising on media seamlessly, the computer-implemented method comprising:
directing, by a computer, an advertisement generator to generate advertising corresponding to each particular winning entity on an electronic-auction (e-auction) website in response to an e-auction component assigning advertising rights to corresponding winning entities; and
overlaying, by the computer, the advertising corresponding to each particular winning entity on a specific set of virtual advertisement placeholders assigned to that particular winning entity within media dynamically while the media is playing on a set of client devices without stopping scene flow of the media.

2. The computer-implemented method of claim 1, further comprising:
generating, by the computer, using an e-auction component, an e-auction website that accepts bids from respective entities for specific virtual advertisement placeholders within the media in response to receiving approval of placement of a plurality of virtual advertisement placeholders within the media from a production team; and
assigning, by the computer, using the e-auction component, the advertising rights for the specific set of virtual advertisement placeholders to a corresponding winning entity on the e-auction website.

3. The computer-implemented method of claim 1, further comprising:
receiving, by the computer, the media from a production team of the media to identify areas within the media for placement of a plurality of virtual advertisement placeholders that will display advertising to an audience while the media is playing; and
identifying, by the computer, using an artificial intelligence-based virtual advertisement placeholder identification component, the areas within the media for the placement of the plurality of virtual advertisement placeholders based on a plurality of factors.

4. The computer-implemented method of claim 3, wherein the plurality of factors include screenplay corresponding to the media, duration of scenes in the media, audience viewing angle of a virtual advertisement placeholder in the media, and time gap between respective virtual advertisement placeholders in the media.

5. The computer-implemented method of claim 3, further comprising:
sending, by the computer, the media with the placement of the plurality of virtual advertisement placeholders within the media to the production team for approval of the placement of the plurality of virtual advertisement placeholders within the media in response to identifying the areas within the media for the placement of the plurality of virtual advertisement placeholders; and
receiving, by the computer, the approval of the placement of the plurality of virtual advertisement placeholders within the media from the production team.

6. The computer-implemented method of claim 1, wherein the computer uses a smart contract component to direct the advertisement generator to generate the advertising corresponding to each particular winning entity on the e-auction website.

7. The computer-implemented method of claim 1, wherein the advertisement generator generates the advertising corresponding to each particular winning entity on the e-auction website based on number of virtual advertisement placeholders in the specific set of virtual advertisement placeholders assigned to that particular winning entity, placement within the media of the number of virtual advertisement placeholders in the specific set of virtual advertisement placeholders assigned to that particular winning entity, time duration of how long the advertising corresponding to that particular winning entity will be viewed by an audience while the media is playing, geographic context advertisement variations as to where the media is playing, and time period context advertisement variations as to when the media is playing.

8. The computer-implemented method of claim 1, wherein the computer uses an artificial intelligence-based generative adversarial network component to overlay the advertising corresponding to each particular winning entity on the specific set of virtual advertisement placeholders assigned to that particular winning entity within the media dynamically.

9. A computer system for dynamically overlaying advertising on media seamlessly, the computer system comprising:
a communication fabric;
a storage device connected to the communication fabric, wherein the storage device stores program instructions; and
a processor connected to the communication fabric, wherein the processor executes the program instructions to:
direct an advertisement generator to generate advertising corresponding to each particular winning entity on an electronic-auction (e-auction) website in response to an e-auction component assigning advertising rights to corresponding winning entities; and
overlay the advertising corresponding to each particular winning entity on a specific set of virtual advertisement placeholders assigned to that particular winning entity within media dynamically while the media is playing on a set of client devices without stopping scene flow of the media.

10. The computer system of claim 9, wherein the processor further executes the program instructions to:
generate, using an e-auction component, an e-auction website that accepts bids from respective entities for specific virtual advertisement placeholders within the media in response to receiving approval of placement of a plurality of virtual advertisement placeholders within the media from a production team; and
assign, using the e-auction component, the advertising rights for the specific set of virtual advertisement placeholders to a corresponding winning entity on the e-auction website.

11. The computer system of claim 9, wherein the processor further executes the program instructions to:
receive the media from a production team of the media to identify areas within the media for placement of a plurality of virtual advertisement placeholders that will display advertising to an audience while the media is playing; and
identify, using an artificial intelligence-based virtual advertisement placeholder identification component, the areas within the media for the placement of the plurality of virtual advertisement placeholders based on a plurality of factors.

12. The computer system of claim 11, wherein the plurality of factors include screenplay corresponding to the media, duration of scenes in the media, audience viewing angle of a virtual advertisement placeholder in the media, and time gap between respective virtual advertisement placeholders in the media.

13. A computer program product for dynamically overlaying advertising on media seamlessly, the computer program product comprising a computer-readable storage medium having program instructions embodied therewith, the program instructions executable by a computer to cause the computer to:
direct an advertisement generator to generate advertising corresponding to each particular winning entity on an electronic-auction (e-auction) website in response to an e-auction component assigning advertising rights to corresponding winning entities; and
overlay the advertising corresponding to each particular winning entity on a specific set of virtual advertisement placeholders assigned to that particular winning entity within media dynamically while the media is playing on a set of client devices without stopping scene flow of the media.

14. The computer program product of claim 13, wherein the program instructions further cause the computer to:
generate, using an e-auction component, an e-auction website that accepts bids from respective entities for specific virtual advertisement placeholders within the media in response to receiving approval of placement of a plurality of virtual advertisement placeholders within the media from a production team; and
assign, using the e-auction component, the advertising rights for the specific set of virtual advertisement placeholders to a corresponding winning entity on the e-auction website.

15. The computer program product of claim 13, wherein the program instructions further cause the computer to:
receive the media from a production team of the media to identify areas within the media for placement of a plurality of virtual advertisement placeholders that will display advertising to an audience while the media is playing; and
identify, using an artificial intelligence-based virtual advertisement placeholder identification component, the areas within the media for the placement of the plurality of virtual advertisement placeholders based on a plurality of factors.

16. The computer program product of claim 15, wherein the plurality of factors include screenplay corresponding to the media, duration of scenes in the media, audience viewing angle of a virtual advertisement placeholder in the media, and time gap between respective virtual advertisement placeholders in the media.

17. The computer program product of claim 15, wherein the program instructions further cause the computer to:
send the media with the placement of the plurality of virtual advertisement placeholders within the media to the production team for approval of the placement of the plurality of virtual advertisement placeholders within the media in response to identifying the areas within the media for the placement of the plurality of virtual advertisement placeholders; and
receive the approval of the placement of the plurality of virtual advertisement placeholders within the media from the production team.

18. The computer program product of claim 13, wherein the computer uses a smart contract component to direct the advertisement generator to generate the advertising corresponding to each particular winning entity on the e-auction website.

19. The computer program product of claim 13, wherein the advertisement generator generates the advertising corresponding to each particular winning entity on the e-auction website based on number of virtual advertisement placeholders in the specific set of virtual advertisement placeholders assigned to that particular winning entity, placement within the media of the number of virtual advertisement placeholders in the specific set of virtual advertisement placeholders assigned to that particular winning entity, time duration of how long the advertising corresponding to that particular winning entity will be viewed by an audience while the media is playing, geographic context advertisement variations as to where the media is playing, and time period context advertisement variations as to when the media is playing.

20. The computer program product of claim 13, wherein the computer uses an artificial intelligence-based generative adversarial network component to overlay the advertising corresponding to each particular winning entity on the specific set of virtual advertisement placeholders assigned to that particular winning entity within the media dynamically.
